(19) United States
(12) Patent Application Publication
(10) Pub. No.: US 2025/0018472 A1
(43) Pub. Date: Jan. 16, 2025

(54) Method Of Manufacturing Shaped Article And Method Of Manufacturing Metal Sintered Compact

(71) Applicant: SEIKO EPSON CORPORATION, Tokyo (JP)

(72) Inventor: Keisuke ITOTSUBO, Hachinohe (JP)

(21) Appl. No.: 18/768,418

(22) Filed: Jul. 10, 2024

(30) Foreign Application Priority Data
Jul. 13, 2023 (JP) 2023-115370

(51) Int. Cl. B22F 10/14; B22F 10/64; B33Y 10/00; B33Y 40/20; B33Y 70/00

(52) U.S. Cl. CPC B22F 10/14; B33Y 10/00; B33Y 70/00; B22F 10/64; B33Y 40/20

(57) ABSTRACT

A method of manufacturing a shaped article includes a powder layer forming step of forming a powder layer formed by spreading a metal powder having an average particle diameter of 1 μm or more and 10 μm or less and an average circularity of 0.70 or more and 1.00 or less, a binder solution supplying step of forming a bound layer in a predetermined region of the powder layer by supplying a droplet of a binder solution having a volume of 1 pL or more and 10 pL or less from an inkjet head at an ejection interval of 90 μm or less while moving the inkjet head at moving speed of 0.1 mm/s or more and 20 mm/s or less with respect to the predetermined region, and an extraction step of extracting the bound layer from the powder layer to obtain the shaped article.

The present application is based on, and claims priority from JP Application Serial Number 2023-115370, filed Jul. 13, 2023, the disclosure of which is hereby incorporated by reference herein in its entirety.

### BACKGROUND

### 1. Technical Field

The present disclosure relates to a method of manufacturing a shaped article and a method of manufacturing a metal sintered compact.

### 2. Related Art

As a technique for shaping a three-dimensional object, an additive manufacturing method using a metal powder is widely used in recent years. As the additive manufacturing method, fused deposition modeling (FDM), selective laser sintering (SLS), a binder-jet method, and the like are known according to a principle of bonding.

JP-T-2006-515813 discloses a solid free shape manufacturing system which ejects droplets different in volume as droplets of a binder to a powder layer using an inkjet printing technique to solidify the powder to thereby manufacture an object. Since the method of manufacturing an object using such a system includes a step of ejecting droplets of a binder, it can be regarded as a kind of binder-jet method. According to such a system, it is possible to manufacture an object finished to have a smooth surface by ejecting the droplets different in volume.

JP-T-2006-515813 is an example of the related art.

In the solid free shape manufacturing system described in JP-T-2006-515813, the problem of finishing an object to have a smooth surface is solved by using a droplet large in volume and a droplet small in volume in combination. However, when a droplet large in volume is ejected, a crater having a high wall is formed in the powder layer. Since this wall tends to remain in the powder layer, it causes deterioration of the surface roughness of the object finally obtained.

On the other hand, it is conceivable that when the volume of the droplet is reduced, the surface roughness of the object to be obtained is improved. However, since the amount of the droplets to be supplied per unit area decreases, the supply amount of the binder is insufficient, and it is assumed that the surface roughness is rather deteriorated or the manufacturing efficiency of the shaped article decreases. Therefore, the conditions for efficiently manufacturing an object having good surface roughness are not optimized, and there is room for consideration.

### SUMMARY

A method of manufacturing a shaped article according to an application example of the present disclosure includes:
a powder layer forming step of forming a powder layer formed by spreading a metal powder having an average particle diameter of 1 μm or more and 10 μm or less and an average circularity of 0.70 or more and 1.00 or less;
a binder solution supplying step of forming a bound layer in a predetermined region of the powder layer by supplying a droplet of a binder solution having a volume of 1 pL or more and 10 pL or less from an inkjet head at an ejection interval of 90 μm or less while moving the inkjet head at moving speed of 0.1 mm/s or more and 20 mm/s or less with respect to the predetermined region; and
an extraction step of extracting the bound layer from the powder layer to obtain the shaped article.

A method of manufacturing a metal sintered compact according to an application example of the present disclosure includes:
a shaping step of obtaining a shaped article by the method of manufacturing the shaped article according to the application example of the present disclosure; and
a sintering step of sintering the shaped article to obtain the metal sintered compact.

### BRIEF DESCRIPTION OF THE DRAWINGS

FIG. 1 is a process drawing illustrating a method of manufacturing a shaped article according to an embodiment.

FIG. 2 is a diagram illustrating the method of manufacturing the shaped article illustrated in FIG. 1.

FIG. 3 is a diagram illustrating the method of manufacturing the shaped article illustrated in FIG. 1.

FIG. 4 is a diagram illustrating the method of manufacturing the shaped article illustrated in FIG. 1.

FIG. 5 is a diagram illustrating the method of manufacturing the shaped article illustrated in FIG. 1.

FIG. 6 is a diagram illustrating the method of manufacturing the shaped article illustrated in FIG. 1.

FIG. 7 is a diagram illustrating the method of manufacturing the shaped article illustrated in FIG. 1.

FIG. 8 is a diagram illustrating the method of manufacturing the shaped article illustrated in FIG. 1.

FIG. 9 is a diagram illustrating the method of manufacturing the shaped article illustrated in FIG. 1.

FIG. 10 is a diagram illustrating the method of manufacturing the shaped article illustrated in FIG. 1.

FIG. 11 is a process diagram illustrating a method of manufacturing a metal sintered compact according to the embodiment.

FIG. 12 is a table showing photographs obtained by observing surfaces of shaped articles manufactured using the metal powders of sample No. 1 and sample No. 4 with a scanning electron microscope, and measured values of arithmetic average roughness Ra of the respective surfaces.

### DESCRIPTION OF EMBODIMENTS

Hereinafter, a preferred embodiment of a method of manufacturing a shaped article and a method of manufacturing a metal sintered compact of the present disclosure will be described in detail with reference to the accompanying drawings.

### 1. Method of Manufacturing Shaped Article

First, the method of manufacturing a shaped article according to the embodiment will be described.

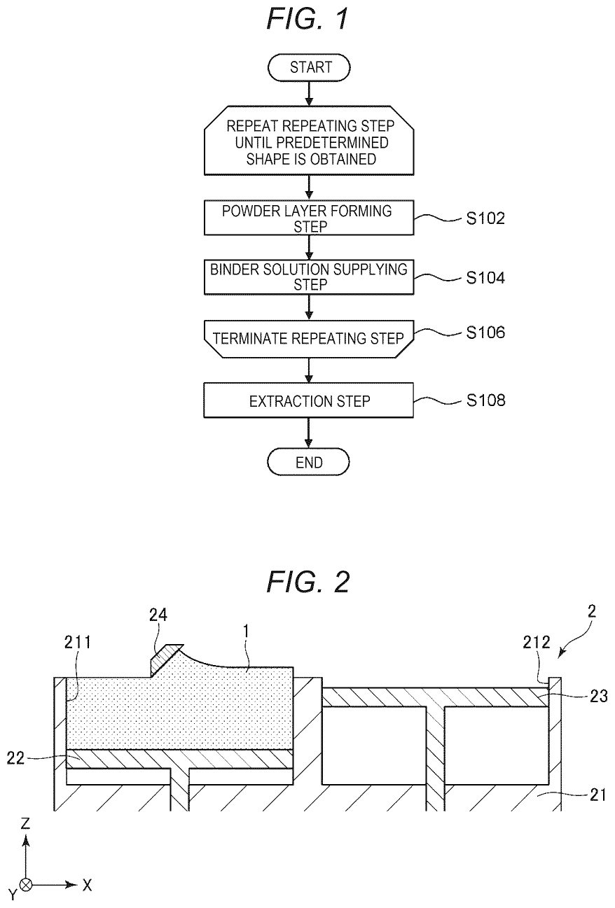

FIG. 1 is a process diagram illustrating the method of manufacturing the shaped article according to the embodiment. FIGS. 2 to 10 are each a diagram illustrating the method of manufacturing the shaped article shown in FIG. 1. In FIGS. 2 to 10, three axes orthogonal to each other are set as an X axis, a Y axis, and a Z axis. Each axis is indicated by an arrow, and a tip side thereof is referred to as a “plus side” whereas a base side thereof is referred to as a “minus side”. In the following description, in particular, a plus side of the Z axis is referred to as “upper”, and a minus side of the Z axis is referred to as “lower”. In addition, both directions parallel to the X axis are referred to as an X-axis direction, both directions parallel to the Y axis are referred to as a Y-axis direction, and both directions parallel to the Z axis are referred to as a Z-axis direction.

The method of manufacturing the shaped article illustrated in FIGS. 1 to 10 is a method called a binder-jet method, and includes a powder layer forming step S102, a binder solution supplying step S104, a repeating step S106, and a extraction step S108 as illustrated in FIG. 1. The binder-jet method does not require a support structure for supporting a shaped article, and thus has an advantage that a shaped article having a complicated shape can be manufactured.

In the powder layer forming step S102, metal powder 1 is spread to form the powder layer 31. In the binder solution supplying step S104, the binder solution 4 is supplied from an inkjet head 26 to a predetermined region of the powder layer 31, and the particles in the powder layer 31 are bound to each other to obtain a bound layer 41. In the repeating step S106, the powder layer forming step S102 and the binder solution supplying step S104 are repeated one or more times to stack the bound layers 41. In the extraction step S108, the bound layer 41 is extracted from the powder layer 31 to obtain the shaped article 6. Hereinafter, the steps will sequentially be described.

### 1.1. Additive Manufacturing Apparatus

First, prior to the description of the powder layer forming step S102, an additive manufacturing apparatus 2 will be described.

The additive manufacturing apparatus 2 includes an apparatus main body 21 having a powder reservoir 211 and a shaping unit 212, a powder supply elevator 22 provided to the powder reservoir 211, a shaping stage 23 provided to the shaping unit 212, and a coater 24, a roller 25, and the inkjet head 26 which are movably provided on the apparatus main body 21.

The powder reservoir 211 is a recess which is provided to the apparatus main body 21 and the upper portion of which opens. The metal powder 1 is stored in the powder reservoir 211. It is arranged that an appropriate amount of the metal powder 1 stored in the powder reservoir 211 is supplied to the shaping unit 212 by the coater 24.

The powder supply elevator 22 is disposed in a bottom portion of the powder reservoir 211. The powder supply elevator 22 is made movable in a vertical direction with the metal powder 1 placed thereon. By moving the powder supply elevator 22 upward, the metal powder 1 placed on the powder supply elevator 22 is pushed up to protrude from the powder reservoir 211. Accordingly, the protruding part of the metal powder 1 can be moved toward the shaping unit 212 side.

The shaping unit 212 is a recess which is provided to the apparatus main body 21 and the upper portion of which opens. The shaping stage 23 is disposed inside the shaping unit 212. The metal powder 1 is laid in layers on the shaping stage 23 by the coater 24. The shaping stage 23 is movable in the vertical direction in a state where the metal powder 1 is spread thereon. By appropriately setting the height of the shaping stage 23, the amount of the metal powder 1 spread on the shaping stage 23 can be controlled.

The coater 24 and the roller 25 extend in the Y-axis direction and are movable in the X-axis direction from the powder reservoir 211 to the shaping unit 212. The coater 24 can level and spread the metal powder 1 in a layered manner by drawing the metal powder 1. The roller 25 compresses the metal powder 1 from above by rolling on the metal powder 1 thus leveled.

The inkjet head 26 is movable in the X-axis direction and the Y-axis direction in the shaping unit 212. The inkjet head 26 supplies a desired amount of a binder solution 4 to a desired position. The inkjet head 26 may include a plurality of ejection nozzles. The binder solution 4 may be ejected simultaneously or with a time difference from the plurality of ejection nozzles.

### 1.2. Powder Layer Forming Step

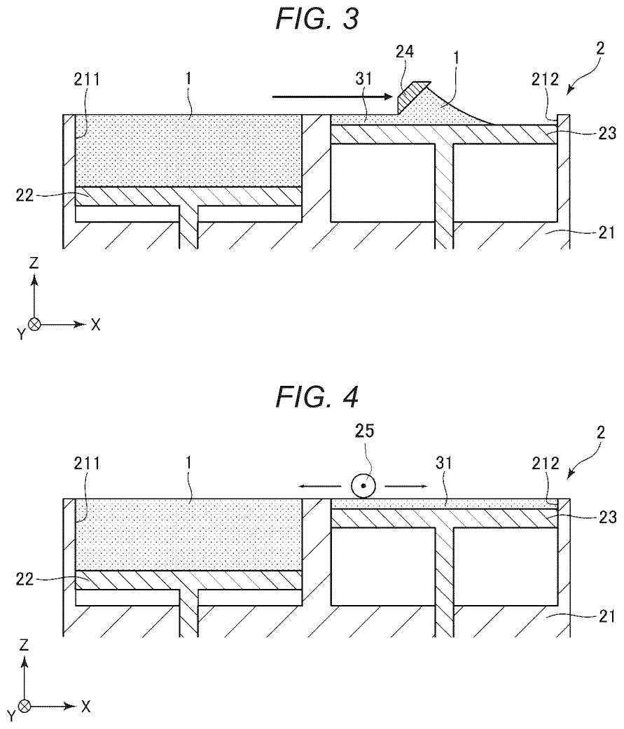

Next, the powder layer forming step S102 using the additive manufacturing apparatus 2 described above will be described. In the powder layer forming step S102, the metal powder 1 is spread on the shaping stage 23 to form the powder layer 31. Specifically, as shown in FIGS. 2 and 3, the coater 24 is used to drag the metal powder 1 stored in the powder reservoir 211 onto the shaping stage 23 and level the metal powder 1 into a uniform thickness. Accordingly, the powder layer 31 shown in FIG. 4 is obtained. On this occasion, the thickness of the powder layer 31 can be controlled by lowering the upper surface of the shaping stage 23 below the upper end of the shaping unit 212 and controlling the lowering amount.

Subsequently, as shown in FIG. 4, the roller 25 is moved in the X-axis direction while compressing the powder layer 31 in a thickness direction by the roller 25. This can increase the filling rate of the metal powder 1 in the powder layer 31. The compression by the roller 25 may be performed as necessary, and may be omitted. The powder layer 31 may be compressed by a device different from the roller 25, such as a pressing plate.

### 1.3. Binder Solution Supplying Step

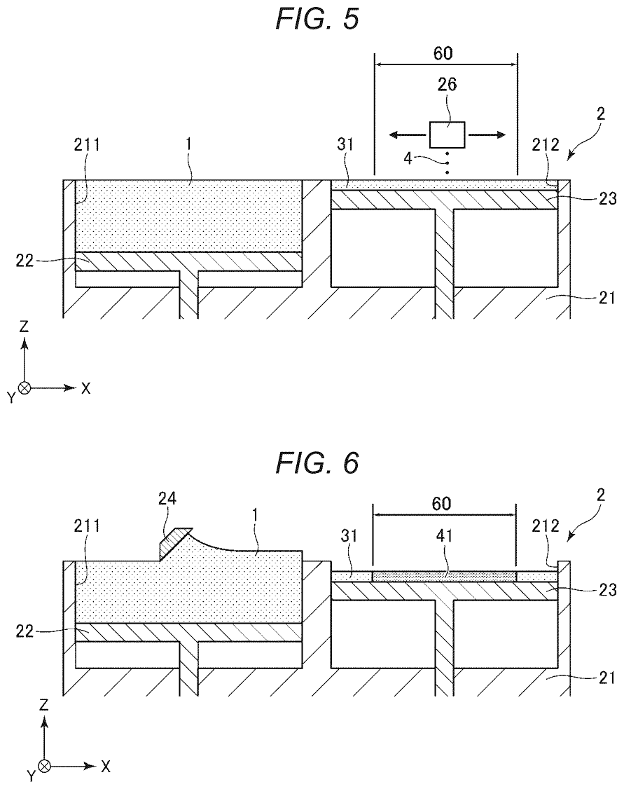

Next, the binder solution supplying step S104 using the additive manufacturing apparatus 2 described above will be described. In the binder solution supplying step S104, as shown in FIG. 5, droplets of the binder solution 4 are supplied from the inkjet head 26 to a forming region 60 corresponding to the shaped article 6 to be shaped out of the powder layer 31. The binder solution 4 is a liquid containing a binder and a solvent or a dispersant.

The inkjet head 26 ejects droplets of the binder solution 4 toward the forming region 60 at ejection intervals of 90 μm or less while moving at moving speed of 0.1 mm/s or more and 20 mm/s or less. In the forming region 60 where the binder solution 4 is ejected, the particles of the metal powder 1 are bound to each other, and the bound layer 41 shown in FIG. 6 is obtained. In the bound layer 41, the particles of the metal powder 1 are bound to each other with the binder, and such a shape keeping property as to prevent the shape from being broken by its own weight is obtained.

The moving speed of the inkjet head 26 is required to be within the range described above, preferably 1 mm/s or more and 15 mm/s or less, and more preferably 3 mm/s or more and 10 mm/s or less. By setting the moving speed of the inkjet head 26 within the above range, it is possible to improve the accuracy of the ejection position of the droplets of the binder solution 4. As a result, the shape accuracy of the bound layer 41 can be increased, and the surface accuracy of the shaped article 6 finally obtained can be increased. When the moving speed of the inkjet head 26 falls below the lower limit value, the manufacturing efficiency of the shaped article 6 decreases. On the other hand, when the moving speed of the inkjet head 26 exceeds the upper limit value, the accuracy of the ejection position of the droplets is reduced, and thus the accuracy of the shape of the bound layer 41 is reduced.

The moving speed of the inkjet head 26 is an average speed of the inkjet head 26 measured at the timing of ejecting droplets of the binder solution 4 toward the forming region 60. The average speed is obtained by measuring the speed of the inkjet head 26 ten times or more at the timing of ejecting droplets, and averaging the speed.

The ejection intervals of the droplets of the binder solution 4 may be within the above range, but are preferably 5 μm or more and 80 μm or less, more preferably 10 μm or more and 70 μm or less, and still more preferably 20 μm or more and 60 μm or less. By setting the ejection intervals of the droplets of the binder solution 4 within the above range, the binder solution 4 can uniformly be supplied in a sufficient amount. The ejection intervals of the droplets of the binder solution 4 may be less than the lower limit value, but in this case, the improvement of the surface accuracy of the shaped article 6 cannot be expected to that extent, but it is difficult to increase the moving speed of the inkjet head 26, and the manufacturing efficiency of the shaped article 6 may decrease. On the other hand, when the ejection intervals of the droplets of the binder solution 4 exceed the upper limit value, the droplets of the binder solution 4 landed on the powder layer 31 are too far from each other to form a continuous coated film. As a result, the probability of occurrence of the particles that cannot be connected increases, and the surface accuracy of the shaped article 6 decreases.

The ejection interval of the droplets of the binder solution 4 is determined by ejecting the binder solution 4 on a smooth surface that does not absorb the binder solution 4 under the same conditions as the ejection to the forming region 60, measuring the interval between the ejected droplets within a range of 5 mm×5 mm, and averaging the measured values. The interval between droplets is the distance between the centers of the droplets adjacent to each other. The average value is obtained by measuring the interval for each of ten or more randomly extracted pairs of droplets and calculating the average value.

The inkjet head 26 sets the volume of the droplets of the binder solution 4 to 1 pL or more and 10 pL or less. The volume of the droplets of the binder solution 4 is preferably 1 pL or more and 8 pL or less, and more preferably 2 pL or more and 6 pL or less. By setting the volume of the droplet of the binder solution 4 within the above range, in particular, the accuracy of the ejection position of the droplet on the outer edge of the bound layer 41 can be improved. Accordingly, it is possible to increase the surface accuracy of a region particularly corresponding to the outer edge of the bound layer 41 out of the shaped article 6. When the volume of the droplet of the binder solution 4 is less than the lower limit value, it is difficult to increase the moving speed of the inkjet head 26, and thus the manufacturing efficiency of the shaped article 6 decreases. On the other hand, when the volume of the droplet of the binder solution 4 exceeds the upper limit value, the mass of the droplets increases. For this reason, the impact when the droplet lands on the powder layer 31 is increased, and the surface accuracy of the bound layer 41 is reduced, which causes the surface accuracy of the shaped article 6 to be reduced.

The volume of the droplet of the binder solution 4 is an average value of the volumes obtained from the observation results obtained by ejecting the binder solution 4 onto a smooth surface that does not absorb the binder solution 4 under the same conditions as those for ejecting the droplets of the binder solution 4 onto the forming region 60, and then observing the droplets thus ejected in plan view and cross-sectional view. The average value means an average value of volumes obtained from 10 or more droplets extracted randomly.

The bound layer 41 may be heated simultaneously with or after the supply of the binder solution 4. Accordingly, volatilization of the solvent or the dispersant contained in the binder solution 4 is promoted, and solidification or curing of the binder promotes binding of the particles. When the binder contains a photocurable resin or a UV-curable resin, light irradiation or UV irradiation may be performed instead of heating or together with heating.

A heating temperature in the heating is not particularly limited, and is preferably 50° C. or higher and 250° C. or lower, and more preferably 70° C. or higher and 200° C. or lower. Accordingly, a sufficient amount of heat can be applied to the bound layer 41, and the volatilization of the solvent or the dispersant can sufficiently be promoted.

The binder solution 4 is not particularly limited as long as the binder solution is a liquid having a component capable of binding the particles of the metal powder 1 to each other. Examples of the solvent or dispersion medium contained in the binder solution 4 include water, alcohols, ketones, and carboxylic acid esters, and the solvent or dispersion medium may be a mixed liquid containing at least one of the above. Examples of the binder contained in the binder solution 4 include fatty acids, paraffin waxes, microcrystalline waxes, polyethylene, polypropylene, polystyrene, acrylic resins, polyamide resins, polyesters, stearic acid, polyvinyl pyrrolidone (PVP), polyvinyl alcohol (PVA), polyethylene glycol (PEG), urethane resins, epoxy resins, vinyl resins, unsaturated polyester resins, and phenolic resins.

In particular, a solution containing polyvinyl alcohol (PVA), polyvinyl pyrrolidone (PVP), and water is preferably used as the binder solution 4. Accordingly, the binder solution 4 has a suitable affinity and a suitable viscosity for the metal powder 1, and also has a good binding property. Therefore, the binder solution 4 contributes to manufacture of the shaped article 6 having particularly good surface accuracy.

The concentration of the binder in the binder solution 4 is preferably 0.1 mass % or more and 20.0 mass % or less, more preferably 1.0 mass % or more and 15.0 mass % or less, and still more preferably 5.0 mass % or more and 12.0 mass % or less. As a result, the viscosity of the binder solution 4 is optimized, and sufficient binding force between the particles of the metal powder 1 can be ensured.

The binder solution 4 may contain an additive in addition to the above components. Examples of the additive include a surfactant, a stabilizer, a viscosity increasing agent, a defoaming agent, and a humectant.

The total content of the additives in the binder solution 4 is preferably 20.0 mass % or less, and more preferably 1.0 mass % or more and 15.0 mass % or less.

### 1.4. Repeating Step

In the repeating step S106, the powder layer forming step S102 and the binder solution supplying step S104 are repeated once or more. That is, these steps are performed twice or more in total. Thus, a plurality of bound layers 41 are stacked. By stacking the bound layers 41 in this manner, the shaped article 6 having a desired three-dimensional shape shown in FIG. 10 is obtained.

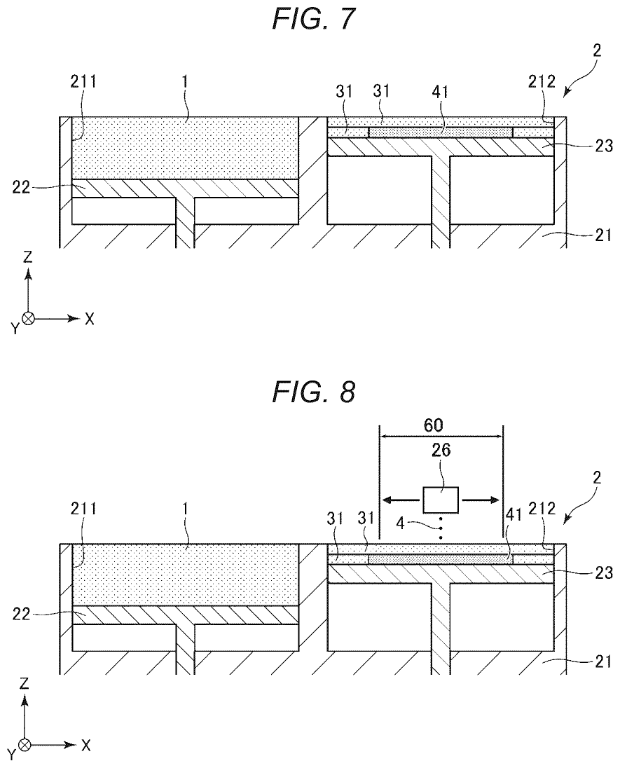

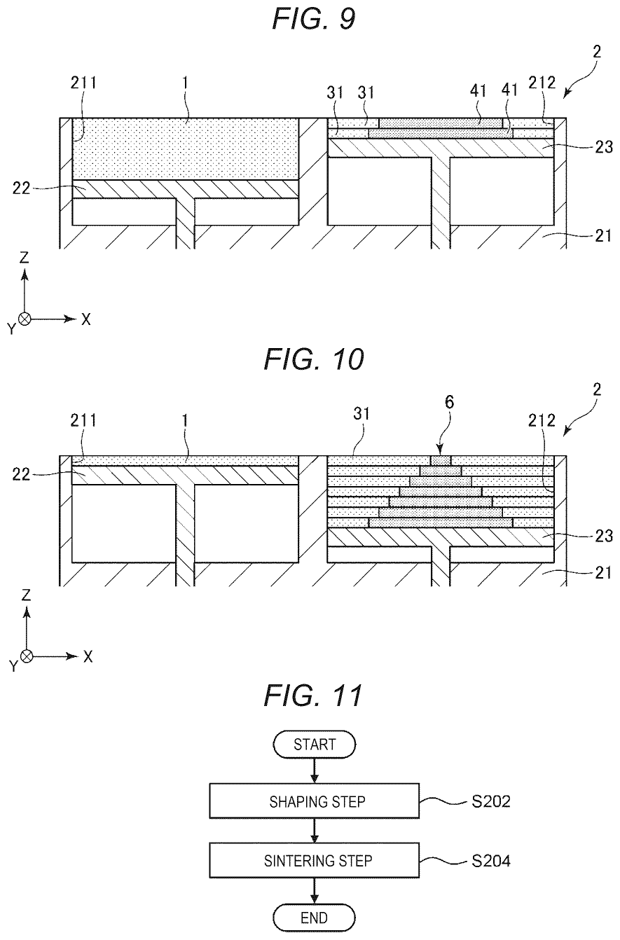

Specifically, first, a new powder layer 31 shown in FIG. 7 is formed on the bound layer 41 shown in FIG. 6. Subsequently, as shown in FIG. 8, the binder solution 4 is supplied to the forming region 60 out of the newly formed powder layer 31. As a result, the bound layer 41 as a second layer shown in FIG. 9 is obtained. The two bound layers 41 may be the same in shape as each other, or different in shape from each other.

### 1.5. Extraction Step

In the extraction step S108, the bound layers 41 are extracted from the powder layers 31. Thus, the shaped article 6 shown in FIG. 10 is obtained.

The smaller the arithmetic average roughness Ra of the surface of the shaped article 6 thus obtained is, the better, but the arithmetic average roughness Ra is preferably 7.0 μm or less, more preferably 0.5 μm or more and 5.0 μm or less, and still more preferably 1.0 μm or more and 4.0 μm or less. Accordingly, the shaped article 6 having sufficient surface accuracy is obtained. By sintering such a shaped article 6, it is possible to manufacture a metal sintered compact having a surface accuracy that does not require secondary processing. Although the arithmetic average roughness Ra may be less than the lower limit value, in this case, there is a possibility that the arithmetic average roughness Ra exceeds the lower limit value depending on the individual difference of the shaped articles 6, and thus the manufacturing yield of the shaped articles 6 may decrease. On the other hand, when the arithmetic average roughness Ra exceeds the upper limit value, the surface accuracy of the shaped article 6 is reduced, and thus the surface accuracy of the metal sintered compact obtained by sintering the shaped article 6 may be reduced.

The arithmetic average roughness Ra of the surface of the shaped article 6 is measured using a non-contact surface roughness measuring apparatus. Examples of such a surface roughness measuring apparatus include a digital microscope VHX-6000 manufactured by Keyence Corporation. The imaging magnification for calculating the arithmetic average roughness Ra is 500 times.

Out of the powder layers 31, the metal powder 1 that does not constitute the bound layers 41 is collected and reused as necessary, that is, used again for manufacturing the shaped article 6.

### 2. Method of Manufacturing Metal Sintered Compact

By performing a sintering treatment on the shaped article 6, a metal sintered compact is obtained. In the sintering treatment, the shaped article 6 is heated to cause a sintering reaction.

FIG. 11 is a process diagram illustrating the method of manufacturing the metal sintered compact according to the embodiment.

The method of manufacturing the metal sintered compact illustrated in FIG. 11 includes a shaping step S202 of obtaining the shaped article 6 by the above-described method of manufacturing the shaped article, and a sintering step S204 of sintering the shaped article 6 to obtain the metal sintered compact.

### 2.1. Shaping Step

In the shaping step S202, the shaped article 6 is obtained by the method of manufacturing the shaped article described above.

### 2.2. Sintering Step

In the sintering step S204, the shaped article 6 is sintered to obtain a metal sintered compact.

A sintering temperature varies depending on a constituent material, a particle diameter, and the like of the metal powder 1, and is preferably 980° C. or higher and 1330° C. or lower, and more preferably 1050° C. or higher and 1260° C. or lower as an example. A sintering time is preferably 0.2 hour or longer and 7 hours or shorter, and more preferably 1 hour or longer and 6 hours or shorter.

An atmosphere in the sintering treatment is, for example, a reducing atmosphere such as hydrogen, an inert atmosphere such as nitrogen or argon, or a reduced-pressure atmosphere obtained by reducing a pressure of such an atmosphere. The pressure in the reduced-pressure atmosphere is not particularly limited as long as the pressure is lower than a normal pressure (100 kPa), and is preferably 10 kPa or less, and more preferably 1 kPa or less.

When the sintering treatment performed under the above-described “main conditions is referred to as sintering”, at one of least 41 “pre-sintering” and “debindering” corresponding to a pretreatment of the main sintering may be performed on the shaped article 6 as necessary. Accordingly, at least a part of the binder contained in the shaped article 6 can be removed, or a part of the shaped article 6 can be sintered. Accordingly, unintended deformation or the like in the main sintering can be suppressed.

A temperature in the pre-sintering or the debindering is not particularly limited as long as the temperature is a temperature at which sintering of a metal powder 1 is not completed, and is preferably 100° C. or higher and 500° C. or lower, and more preferably 150° C. or higher and 300° C. or lower. A duration of the pre-sintering or the debindering in the temperature range described above is preferably 5 minutes or longer, more preferably 10 minutes or longer and 120 minutes or shorter, and still more preferably 20 minutes or longer and 60 minutes or shorter. An atmosphere in the pre-sintering or the debindering is, for example, an ambient atmosphere, an inert atmosphere such as nitrogen or argon, or a reduced-pressure atmosphere obtained by reducing a pressure of such an atmosphere.

The metal sintered compact obtained as described above can be used as a material constituting all or a part of a component for transportation equipment such as a component for an automobile, a component for a bicycle, a component for a railway vehicle, a component for a ship, a component for an aircraft, or a component for a spacecraft, a component for an electronic device such as a component for a personal computer, a component for a mobile phone terminal, a component for a tablet terminal, or a component for a wearable terminal, a component for electrical equipment such as a refrigerator, a washing machine, or a cooling and heating machine, a component for a machine such as a machine tool or a semi-conductor manufacturing apparatus, a component for a plant such as a nuclear power plant, a thermal power plant, a hydroelectric power plant, an oil refinery, or a chemical complex, a component for a timepiece, a metal utensil, and a decorative item such as jewelry or an eyeglass frame.

### 3. Metal Powder

Next, the metal powder 1 will be described.

### 3.1. Constituent Material

The metal powder 1 contains a metal material. The metal material contained in the metal powder 1 is not particularly limited, but is a material having a sintering property when a metal sintered compact is manufactured from the shaped article 6. Examples of the metal material having a sintering property include simple substances such as Fe, Ni, Co, Ti, Al, and Mg, and alloys and intermetallic compounds containing the simple substances as main components. Among them, an Fe-based metal material is preferably used as the metal material. The Fe-based metal material refers to a metal material having an Fe content of more than 50% in terms of an atomic ratio. The Fe-based metal material is easily available and can be used to produce a metal sintered compact having excellent mechanical properties.

Examples of the Fe-based metal material include stainless steel such as ferritic stainless steel, austenitic stainless steel, martensitic stainless steel, precipitation-hardening stainless steel, and austenitic-ferritic (duplex) stainless steel, low-carbon steel, carbon steel, heat-resistant steel, die steel, high-speed tool steel, an Fe—Ni alloy, and an Fe—Ni—Co alloy.

Among these, stainless steel is preferably used as the Fe-based metal material. Stainless steel is a type of steel excellent in mechanical strength and corrosion resistance. Therefore, by using the metal powder 1 made of stainless steel, a metal sintered compact having excellent mechanical strength and corrosion resistance and having high shape accuracy can be efficiently produced.

Examples of the austenitic stainless steel include SUS301, SUS301L, SUS301J1, SUS302B, SUS303, SUS304, SUS304Cu, SUS304L, SUS304N1, SUS304N2, SUS304LN, SUS304J1, SUS304J2, SUS305, SUS309S, SUS310S, SUS312L, SUS315J1, SUS315J2, SUS316, SUS316L, SUS316N, SUS316LN, SUS316Ti, SUS316J1, SUS316J1L, SUS317, SUS317L, SUS317LN, SUS317J1, SUS317J2, SUS836L, SUS890L, SUS321, SUS347, SUSXM7, and SUSXM15J1.

Examples of the ferritic stainless steel include SUS405, SUS410L, SUS429, SUS430, SUS430LX, SUS430J1L, SUS434, SUS436L, SUS436J1L, SUS445J1, SUS445J2, SUS444, SUS447J1, and SUSXM27.

Examples of the martensitic stainless steel include SUS403, SUS410, SUS410S, SUS420J1, SUS420J2, and SUS440A.

Examples of the precipitation-hardening stainless steel include SUS630 and SUS631.

Examples of the austenitic-ferritic (duplex) stainless steel include SUS329J1, SUS329J3L, and SUS329J4L.

The above-described symbols are material symbols based on the JIS standards. The types of stainless steel in the specification are distinguished by the above-described material symbols.

The shaped article 6 may be manufactured using the metal powder 1 containing different types of stainless steel. For example, when the shaped article 6 includes the two or more bound layers 41, one of the bound layers 41 may be manufactured using the metal powder 1 containing the first stainless steel, and another of the bound layers 41 may be manufactured using the metal powder 1 containing the second stainless steel.

The metal powder 1 may be provided with a coating film that coats a surface of a core particle formed of a metal material. The coating film is provided, for example, for the purpose of enhancing the fluidity and filling property of the metal powder 1, and enhancing the affinity between the metal powder 1 and the binder. Examples of the constituent material of the coating film include organic materials such as resin, inorganic materials such as ceramics and glass, and compounds derived from a coupling agent.

### 3.2. Various Characteristics of Metal Powder

Next, various characteristics of the metal powder 1 will be described. All of the following characteristics are characteristics measured in a state where the metal powder 1 is not provided with the above-described coating film.

### 3.2.1. Particle Diameter Distribution

Regarding the metal powder 1 according to the present embodiment, when a volume-based particle diameter distribution is obtained by a laser diffraction type particle diameter distribution measuring apparatus, a particle diameter when a cumulative frequency is 10% from a small diameter side is defined as D10. Similarly, particle diameters when the cumulative frequency is 50% and 90% from the small diameter side are defined as D50 and D90. An example of the apparatus for measuring the particle diameter distribution is Microtrac HRA 9320-X100 manufactured by Nikkiso Co., Ltd.

The metal powder 1 has a particle diameter D50 (average particle diameter D50) of 1.0 μm or more and 10.0 μm or less, preferably 2.0 μm or more and 9.0 μm or less, and more preferably 3.0 μm or more and 8.0 μm or less. This makes it possible to achieve both the filling property and the fluidity of the metal powder 1. As a result, the dense shaped article 6 having high surface accuracy can be obtained, and by using the shaped article 6, the metal sintered compact having high density and high surface accuracy can finally be manufactured.

When the particle diameter D50 is less than the lower limit value, the particles of the metal powder 1 are easily aggregated. Therefore, the fluidity of the metal powder 1 decreases, and the filling property and the surface accuracy of the shaped article 6 decrease. On the other hand, when the particle diameter D50 exceeds the upper limit value, the particles of the metal powder 1 themselves become large. Therefore, the particle shape is easily reflected on the surface of the shaped article 6, and the surface accuracy is reduced.

The ratio D10/D50 of the particle diameter D10 to the particle diameter D50 is preferably 0.30 or more and 0.70 or less, more preferably 0.35 or more and 0.60 or less, and still more preferably 0.42 or more and 0.55 or less. As a result, the particle diameter of the metal powder 1 becomes relatively uniform, so that the fluidity can easily be increased and the sintering property can be ensured. When the ratio D10/D50 is less than the lower limit value, the particle diameter distribution is widened, and the fluidity may decrease. On the other hand, when the ratio D10/D50 is larger than the upper limit value, the particle diameter distribution is, conversely, excessively narrow, it is difficult to increase the filling rate, and the sintering property may decrease.

The ratio D90/D50 of the particle diameter D90 to the particle diameter D50 is preferably 1.50 or more and 2.70 or less, more preferably 1.70 or more and 2.60 or less, and still more preferably 1.90 or more and 2.50 or less. As a result, the particle diameter of the metal powder 1 becomes relatively uniform, so that the fluidity can easily be increased and the sintering property can be ensured. When the ratio D90/D50 is less than the lower limit value, the particle diameter distribution is narrowed, and it is difficult to increase the filling rate, and the sintering property may be deteriorated. On the other hand, when the ratio D90/D50 exceeds the upper limit value, the particle diameter distribution is widened, and the fluidity may decrease.

The particle diameter difference D90-D10 between the particle diameter D90 and the particle diameter D10 is preferably 5.0 μm or more and 18.0 μm or less, more preferably 8.0 μm or more and 15.0 μm or less, and still more preferably 9.0 μm or more and 13.0 μm or less. Accordingly, the particle diameter distribution of the metal powder 1 is optimized, and high fluidity is obtained. As a result, the filling property of the metal powder 1 is improved, and the shaped article 6 which is dense and has high surface accuracy can be obtained.

When the particle diameter difference D90-D10 is less than the lower limit value, the particle diameter distribution of the metal powder 1 becomes too narrow, it is difficult to increase the filling rate, and therefore, the surface accuracy of the shaped article 6 may decrease. On the other hand, when the particle diameter difference D90-D10 exceeds the upper limit value, the particle diameter distribution of the metal powder 1 is widened, and the fluidity decreases. Therefore, the surface accuracy of the shaped article 6 to be manufactured may decrease.

### 3.2.2. Average Circularity

The average circularity of the metal powder 1 is 0.70 or more and 1.00 or less, preferably 0.80 or more and 0.98 or less, and more preferably 0.85 or more and 0.97 or less. Accordingly, even when the particle diameter of the metal powder 1 is small, the particles are easily rolled, and the filling state can be brought close to the close-packed state. As a result, both the filling property and fluidity of the metal powder 1 can be achieved. Thus, the dense shaped article 6 having high surface accuracy can be obtained, and by using the shaped article 6, the metal sintered compact having high density and high surface accuracy can finally be manufactured.

When the average circularity is less than the lower limit value, the fluidity of the metal powder 1 decreases, and the filling rate decreases. On the other hand, when the average circularity is more than the upper limit value, the degree of difficulty in production increases, and the manufacturing efficiency of the metal powder 1 decreases.

The average circularity of the metal powder 1 is measured as follows.

First, an image (secondary electron image) of the metal powder 1 is taken by a scanning electron microscope (SEM). Subsequently, the image obtained is read into image processing software. As the image processing software, for example, image analysis type particle diameter distribution measurement software “Mac-View” made by Moun-tec is used. The imaging magnification is adjusted so that 50 or more and 100 or less particles appear in one image. Then, a plurality of images are acquired to obtain 300 or more particle images in total.

Subsequently, the circularity of 300 or more particle images is calculated using the image processing software to obtain an average value. The average value thus obtained is the average circularity of the metal powder 1. When a circularity is represented by e, an area of the particle images is represented by S, and a perimeter of the particle images is represented by L, the circularity e is determined by the following formula.

$$e = 4 π S / {L}^{2}$$

### 3.2.3. Oxygen Content

The oxygen content of the metal powder 1 is preferably 1000 ppm or less, more preferably 1500 ppm or more and 3500 ppm or less, and still more preferably 2000 ppm or more and 3000 ppm or less in terms of mass ratio. When the oxygen content is within the above range, it is possible to suppress the temporal change of the characteristics while suppressing the adsorption of moisture. That is, the metal powder 1 high in storage stability is obtained.

When the oxygen content is less than the lower limit value, the oxide film located on the particle surface of the metal powder 1 becomes thin, and a change with time is likely to occur. On the other hand, when the oxygen content is more than the upper limit value, moisture is easily adsorbed, the amount of moisture increases, and the fluidity of the metal powder 1 may be reduced.

The oxygen content of the metal powder 1 is measured according to, for example, the general rule of oxygen quantification method of a metal material specified in JIS Z 2613:2006. Specifically, measurement can be performed using an oxygen/nitrogen analyzer, TC-300/EF-300 made by LECO Corporation, an oxygen/nitrogen/hydrogen analyzer, ONH 836 made by LECO Corporation, or the like.

### 4. Method of Manufacturing Metal Powder

Next, an example of a method of manufacturing the metal powder 1 will be described.

The metal powder 1 may be manufactured by any manufacturing method, and is manufactured by, for example, an atomization method. In the atomization method, a molten metal is caused to flow down from a crucible and collide with a fluid such as a liquid or a gas ejected at a high speed. The molten metal colliding with the fluid falls inertially, and therefore, at this time, becomes a spherical liquid droplet. As a result, it is possible to produce the metal powder 1 having high average circularity and a relatively small specific surface area despite a relatively small diameter.

Examples of the atomization method include a water atomization method, a gas atomization method, and a rotating water jet atomization method, depending on a difference in a type of a cooling medium and an apparatus configuration. Among them, the metal powder 1 manufactured by the water atomization method is preferably used. In the water atomization method, since the molten metal is refined by using a fluid having a large specific gravity, that is, water, the metal powder 1 having a small diameter and a narrow particle diameter distribution is obtained. Such the metal powder 1 is excellent in fluidity despite the small diameter, and therefore finally makes a contribution to the manufacture of the shaped article 6 having high surface accuracy.

A flow rate of the molten metal varies depending on an apparatus size and the like, and is preferably more than 1.0 [kg/min] and 20.0 [kg/min] or less, and more preferably 2.0 [kg/min] or more and 10.0 [kg/min] or less. Accordingly, it is possible to optimize an amount of the molten metal flowing down during a certain time, and thus the metal 1 having powder a narrow particle size distribution and being sufficiently spherical can be efficiently produced. As a result, it is possible to produce the metal powder 1 having high average circularity and a relatively small specific surface area despite a relatively small diameter.

A temperature (casting temperature) of the molten metal in the crucible is preferably set, with respect to a melting point Tm [° C.] of a constituent material of the metal powder 1, to Tm+100° C. or more and Tm+350° C. or less, more preferably Tm+180° C. or more and Tm+320° C. or less, and still more preferably Tm+250° C. or more and Tm+300° C. or less. Accordingly, it is possible to ensure a time during which the molten metal is present longer than that in the related art when the molten metal is refined and solidified by various atomization methods. As a result, it is possible to manufacture the metal powder 1 having high average circularity and a relatively small specific surface area despite a small diameter.

In various atomization methods, an outer diameter of a fine stream when the molten metal flows down is not particularly limited, and is preferably 3.0 mm or less, more preferably 0.3 mm or more and 2.0 mm or less, and still more preferably 0.5 mm or more and 1.5 mm or less. Accordingly, the fluid can easily and uniformly be applied to the molten metal, and thus the metal powder 1 having the average particle diameter as described above and the good average circularity can be manufactured.

The metal powder 1 thus produced may be classified as necessary. Examples of classification methods include dry classification such as sieving classification, inertial classification, and centrifugal classification, and wet classification such as sedimentation classification.

### 5. Advantages of Embodiment

As described above, the method of manufacturing the shaped article according to the embodiment described above includes the powder layer forming step S102, the binder solution supplying step S104, and the extraction step S108. In the powder layer forming step S102, the powder layer 31 is formed by spreading the metal powder 1 having the average particle diameter of 1 μm or more and 10 μm or less and the average circularity of 0.70 or more and 1.00 or less. In the binder solution supplying step S104, droplets of the binder solution 4 having a volume of 1 pL or more and 10 pL or less are supplied from the inkjet head 26 to the forming region 60 (predetermined region) of the powder layer 31 at the ejection intervals of 90 μm or less while the inkjet head 26 is moved at the moving speed of 0.1 mm/s or more and 20 mm/s or less. In this way, the bound layer 41 is formed in the forming region 60. In the extraction step S108, the bound layer 41 is extracted from the powder layer 31 to obtain the shaped article 6.

According to such a configuration, since the average particle diameter D50 and the average circularity of the metal powder 1, the movement conditions of the inkjet head 26, and the ejection conditions of the binder solution 4 are respectively optimized, it is possible to efficiently manufacture the shaped article 6 with high surface accuracy in the manufacture of the shaped article 6 by the binder-jet method.

The binder solution 4 may contain polyvinyl alcohol (PVA) or polyvinyl pyrrolidone (PVP), and water.

According to such a configuration, the binder solution 4 has an appropriate affinity for the metal powder 1 and an appropriate degree of viscosity, and also has a good binding property. Therefore, the binder solution 4 contributes to manufacture of the shaped article 6 having particularly good surface accuracy.

In addition, the metal powder 1 may be a powder manufactured by the water atomization method.

In the water atomization method, since the molten metal is refined by using a fluid having a large specific gravity, that is, water, the metal powder 1 having a small diameter and a narrow particle diameter distribution is obtained. Such a metal powder 1 is excellent in fluidity despite the small diameter, and therefore finally makes a contribution to the manufacture of the shaped article 6 having high surface accuracy.

The method of manufacturing a shaped article according to the embodiment described above may include the repeating step S106. In the repeating step S106, the powder layer forming step S102 and the binder solution supplying step S104 are repeated to form the plurality of stacked bound layers 41 as the shaped article 6.

According to such a configuration, the shaped article 6 having a desired three-dimensional shape can be manufactured.

The arithmetic average roughness Ra of the surface of the shaped article 6 is preferably 7.0 μm or less.

According to such a configuration, the shaped article 6 having sufficient surface accuracy is obtained. Further, by sintering the shaped article 6 satisfying such a surface roughness, it is possible to manufacture a metal sintered compact having the surface accuracy that does not require secondary processing.

The ejection intervals describe above are preferably 20 μm or more.

According to such a configuration, it is possible to suppress the moving speed of the inkjet head 26 from becoming too low, and it is possible to increase the manufacturing efficiency of the shaped article 6.

The method of manufacturing a metal sintered compact according to the embodiment includes the shaping step S202 and the sintering step S204. In the shaping step S202, the shaped article 6 is obtained by the method of manufacturing the shaped article according to the embodiment. In the sintering step S204, the shaped article 6 is sintered to obtain a metal sintered compact.

According to such a configuration, a metal sintered compact having high surface accuracy can efficiently be manufactured.

Although the method of manufacturing a shaped article and the method of manufacturing a metal sintered compact according to the present disclosure are hereinabove described based on the illustrated embodiment, the present disclosure is not limited thereto, and for example, any desired steps may be added to the above-described embodiment.

### EXAMPLES

Next, specific examples according to the present disclosure will be described.

### 6. Production of Metal Powder

First, metal powders having different particle diameters were manufactured by a water atomization method while changing production conditions. The constituent material of the metal powder was precipitation hardening stainless steel SUS630 (17-4PH).

Subsequently, the average particle diameter D50, the average circularity, and the oxygen content of the metal powder thus manufactured were measured. The measurement results are shown in Table 1.

### 7. Manufacture of Shaped Article

Subsequently, using the metal powder of each sample number, a shaped article having a rectangular parallelepiped shape was manufactured by the binder-jet method. The shaped article manufactured had a length of 40 mm, a width of 20 mm, and a thickness of 5 mm in size. As the binder solution, an aqueous solution containing PVP at a concentration of 10% by mass and a humectant at a concentration of 12% was used. The volume of the droplets of the binder solution, the moving speed of the inkjet head, and the ejection intervals of the droplets of the binder solution in the binder-jet method are shown in Table 1. In Table 1, among the shaped articles of the respective sample numbers, those corresponding to the present disclosure were evaluated as “Example”, and those not corresponding to the present disclosure were evaluated as “Comparative Example”. 8. Evaluation of Shaped Article

### 8.1. Relative Density of Shaped Article

The mass and the volume of the shaped article manufactured using the metal powder of each sample number were measured, and the density was calculated. Subsequently, the density measured was divided by the true density of the metal powder to calculate the relative density. Then, the relative density calculated was relatively evaluated in view of the following evaluation criteria. The evaluation results are shown in Table 1.
A: The relative density is relatively high.
B: The relative density is relatively medium.
C: The relative density is relatively low.

### 8.2. Surface Roughness of Shaped Article

The surface of the shaped article obtained was observed with a digital microscope having a function as a non-contact type surface roughness measuring apparatus. Then, the arithmetic average roughness Ra of the surface of the shaped article was measured. Then, the measurement results were evaluated according to the following evaluation criteria. The evaluation results are shown in Table 1.
A: The arithmetic average roughness Ra is 4.0 μm or less.
B: The arithmetic average roughness Ra is more than 4.0 μm and 7.0 μm or less.
C: The arithmetic average roughness Ra is more than 7.0 μm.

TABLE 1

| | | | | | Ejection Conditions | | | | |
|---|---|---|---|---|---|---|---|---|---|
| | | | | | of Binder Solution | | | | |
| | | Characteristics of Metal Powder | | | | Head | | Evaluation Results | |
| | | Average Particle | Average | Oxygen | Volume of | Moving | Ejection | Relative | Surface |
| Sample | | Diameter D50 | Circularity | Content | Droplet | Speed | Interval | Density | Roughness |
| No. | Classification | μm | — | ppm | pL | mm/s | μm | — | — |
| 1 | Examples | 6.5 | 0.92 | 2443 | 1 | 10 | 21 | A | A |
| 2 | Examples | 6.5 | 0.92 | 2443 | 5 | 10 | 21 | A | A |
| 3 | Examples | 6.5 | 0.92 | 2443 | 10 | 10 | 21 | A | B |
| 4 | Comparative | 6.5 | 0.92 | 2443 | 15 | 10 | 21 | A | C |
| | Example | | | | | | | | |
| 5 | Examples | 6.5 | 0.92 | 2443 | 3 | 1 | 21 | A | A |
| 6 | Examples | 6.5 | 0.92 | 2443 | 3 | 10 | 21 | A | A |
| 7 | Examples | 6.5 | 0.92 | 2443 | 3 | 20 | 21 | A | B |
| 8 | Comparative | 6.5 | 0.92 | 2443 | 3 | 30 | 21 | A | C |
| | Example | | | | | | | | |
| 9 | Examples | 6.5 | 0.92 | 2443 | 1 | 8 | 42 | A | A |
| 10 | Comparative | 6.5 | 0.92 | 2443 | 1 | 25 | 85 | B | C |
| | Example | | | | | | | | |
| 11 | Comparative | 6.5 | 0.92 | 2443 | 1 | 10 | 100 | B | C |
| | Example | | | | | | | | |
| 12 | Examples | 7.0 | 0.95 | 2582 | 5 | 10 | 42 | A | B |
| 13 | Comparative | 12.0 | 0.92 | 2100 | 5 | 10 | 85 | C | C |
| | Example | | | | | | | | |
| 14 | Comparative | 15.0 | 0.95 | 1580 | 10 | 10 | 42 | C | C |
| | Example | | | | | | | | |
| 15 | Comparative | 7.0 | 0.68 | 4590 | 10 | 10 | 85 | B | C |
| | Example | | | | | | | | |
| 16 | Examples | 2.0 | 0.78 | 6780 | 5 | 1 | 42 | B | B |
| 17 | Examples | 2.0 | 0.78 | 6780 | 5 | 1 | 85 | B | B |
| 18 | Comparative | 2.0 | 0.78 | 6780 | 5 | 1 | 100 | B | C |
| | Example | | | | | | | | |
| 19 | Examples | 6.5 | 0.92 | 2443 | 3 | 10 | 42 | B | B |
| 20 | Examples | 6.5 | 0.92 | 2443 | 3 | 10 | 85 | B | B |
| 21 | Examples | 2.0 | 0.78 | 6780 | 5 | 20 | 42 | B | B |
| 22 | Comparative | 0.8 | 0.71 | 9800 | 5 | 20 | 85 | C | C |
| | Example | | | | | | | | |
| 23 | Examples | 9.0 | 0.95 | 1860 | 1 | 10 | 42 | A | A |
| 24 | Examples | 9.0 | 0.95 | 1860 | 5 | 10 | 42 | A | A |
| 25 | Comparative | 4.0 | 0.55 | 9500 | 1 | 10 | 21 | C | C |
| | Example | | | | | | | | |
| 26 | Comparative | 7.0 | 0.95 | 2582 | 0.5 | 1 | 21 | C | C |
| | Example | | | | | | | | |

As shown in Table 1, in each Example, a shaped article having a small surface roughness was successfully manufactured without excessively reducing the moving speed of the inkjet head or excessively reducing the ejection intervals of the droplets. From the above results, it is found that in the present disclosure, a shaped article having high surface accuracy can efficiently be manufactured.

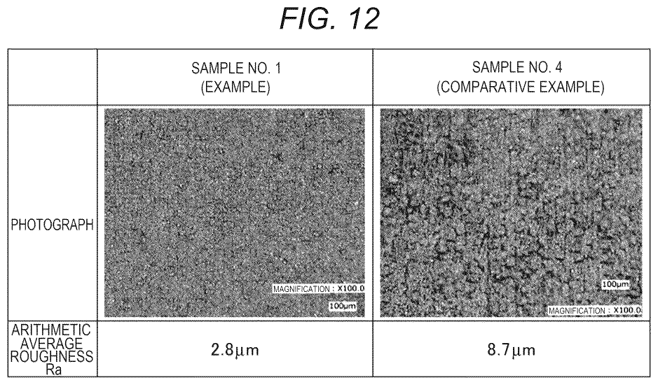

FIG. 12 is a table showing photographs obtained by observing surfaces of shaped articles manufactured using the metal powders of sample No. 1 and sample No. 4 with the scanning electron microscope, and the measured values of the arithmetic average roughness Ra of the respective surfaces.

As shown in FIG. 12, it can be seen from the photograph that the shaped article manufactured by the manufacturing method of Example is small in the arithmetic average roughness Ra and is relatively smooth. In contrast, it can be seen from the photograph that the shaped article manufactured by the manufacturing method of the comparative example is large in the arithmetic average roughness Ra and is relatively coarse.

What is claimed is:

1. A method of manufacturing a shaped article, comprising:
a powder layer forming step of forming a powder layer formed by spreading a metal powder having an average particle diameter of 1 μm or more and 10 μm or less and an average circularity of 0.70 or more and 1.00 or less;
a binder solution supplying step of forming a bound layer in a predetermined region of the powder layer by supplying a droplet of a binder solution having a volume of 1 pL or more and 10 pL or less from an inkjet head at an ejection interval of 90 μm or less while moving the inkjet head at moving speed of 0.1 mm/s or more and 20 mm/s or less with respect to the predetermined region; and
an extraction step of extracting the bound layer from the powder layer to obtain the shaped article.

2. The method according to claim 1, wherein
the binder solution contains polyvinyl alcohol (PVA) or polyvinyl pyrrolidone (PVP), and water.

3. The method according to claim 1, wherein
the metal powder is a powder manufactured by a water atomization method.

4. The method according to claim 1, further comprising
a repeating step of obtaining a plurality of the bound layers stacked on one another as the shaped article by repeating the powder layer forming step and the binder solution supplying step.

5. The method according to claim 1, wherein
an arithmetic average roughness Ra of a surface of the shaped article is 7.0 μm or less.

6. The method according to claim 1, wherein
the ejection interval is 20 μm or more.

7. A method of manufacturing a metal sintered compact comprising:
a shaping step of obtaining a shaped article by the method of manufacturing the shaped article according to claim 1; and
a sintering step of sintering the shaped article to obtain the metal sintered compact.
